(19) United States
(12) Patent Application Publication
(10) Pub. No.: US 2004/0198344 A1
(43) Pub. Date: Oct. 7, 2004

(54) Integrated wireless voice and data services using mobile switching centers

(76) Inventors: Randall E. Pitt, Batavia, IL (US); Steven E. Sommars, Wheaton, IL (US)

Correspondence Address: CARLSON, GASKEY & OLDS, P.C., 400 WEST MAPLE ROAD, SUITE 350, BIRMINGHAM, MI, 48009, US

(21) Appl. No.: 10/341,609

(22) Filed: Jan. 14, 2003

(51) Int. Cl. H04M 3/42; H04Q 7/20

(52) U.S. Cl. 455/426.1; 455/466; 455/414.1

(57) ABSTRACT

A wireless communication system includes an interface that facilitates direct communication for exchanging data between a data network and a mobile switching center. In one example, the communication interface is a device server at the mobile switching center. Exchanging data between the mobile switching center and the data network allows for selectively integrating voice communication and data services. A number of example integrated service scenarios are disclosed.

### BACKGROUND OF THE INVENTION

1. Field of the Invention

This invention generally relates to wireless communication systems. More particularly, this invention relates to integrating wireless voice communication and wireless data services.

2. Description of the Related Art

Wireless voice communications and wireless packet data services have become widespread. Cellular phone users obtain access to public switched telephony networks (PSTNs) through known circuit-switched services. A mobile switching center (MSC) provides circuit-switched services. Wireless data access has been accomplished through gateways that interface to data networks, such as the internet. The universal mobile telecommunications system (UMTS) provides for such circuit-switched voice services and wireless packet data services.

The standard universal mobile telecommunications system UMTS and GSM/GPRS system architecture includes a gateway support node (GGSN) that anchors a subscriber's packet data session. The GGSN serves as a gateway to the data network. In some instances, the mobile station will exchange packets with a wireless access protocol (WAP) gateway. Serving GPRS support nodes (SGSNs) and radio network controllers (RNCs) provide mobility management and maintain the packet data session as the subscriber moves through a UMTS cellular network.

The standard CDMA2000 system architecture includes a packet data serving node (PDSN) that anchors a subscriber's packet data session. Packet control functions (PCFs) provide mobility management and maintain the packet data session as the subscriber moves through a CDMA2000 cellular network.

In the standard architecture, one limitation is that there is very little integration of the voice and data services. The MSC handling the circuit-switched voice services typically operates independently of the GGSN, which handles packet data services. While there is some capability for subscribers to initiate wireless circuit-switched calls using a WAP browser on their mobile communication devices, there are limitations with the current approach. For example, it is not possible to initiate a call from a mobile station that does not include the mobile station as one of the parties on the call. Further, the mobile switching center does not exchange data directly with the WAP gateway, which requires that any call initiation begin with signaling from the mobile station.

This invention provides enhanced integrated voice and data services by allowing the portion(s) of a network handling packet data services to exchange data directly with the mobile switching center.

### SUMMARY OF THE INVENTION

In general terms, this invention is a method of integrating voice communication and packet data services, by exchanging data between a mobile switching center and a gateway of a packet data network handling data services.

An example method of this invention for integrating wireless voice communication and wireless packet data services includes using a mobile switching center to facilitate voice communication services for the mobile subscriber. A packet data network facilitates data services for the mobile subscriber. Exchanging data between the mobile switching center and a gateway of the packet data network selectively integrates voice communication and packet data services on behalf of the mobile subscriber.

In some example scenarios, the mobile switching center initiates communication with a packet data gateway such as a WAP gateway, a GGSN or a PDSN depending on the particulars of the data network and the needs of a particular situation. In other example scenarios facilitated by this invention, the WAP gateway, the GGSN or the PDSN initiates access to the mobile switching center.

An example system designed according to this invention includes a packet data network that facilitates data services for a mobile subscriber. A mobile switching center accesses a public switch telephone network to facilitate voice communication services for the mobile subscriber. The mobile switching center has a data exchanging interface for direct communication with a gateway of the packet data network such as a WAP gateway, a GGSN or a PDSN. The data exchanged between the mobile switching center and the packet data network allows for selectively integrating the data services and voice communication services for the mobile subscriber.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically illustrates a wireless communication system designed according to this invention.

FIG. 1A schematically illustrates one example mobile switching center useful in an embodiment of this invention.

FIG. 2 is a flow chart diagram summarizing an example integration of voice and data services provided by an embodiment of this invention.

FIG. 3 is a flow chart diagram summarizing another example integration of voice and data services provided by an embodiment of this invention.

FIG. 4 is a flow chart diagram summarizing another example integration of voice and data services provided by an embodiment of this invention.

FIG. 5 is a flow chart diagram summarizing another example integration of voice and data services provided by an embodiment of this invention.

FIG. 6 is a flow chart diagram summarizing another example integration of voice and data services provided by an embodiment of this invention.

FIG. 7 is a flow chart diagram summarizing another example integration of voice and data services provided by an embodiment of this invention.

### DETAILED DESCRIPTION

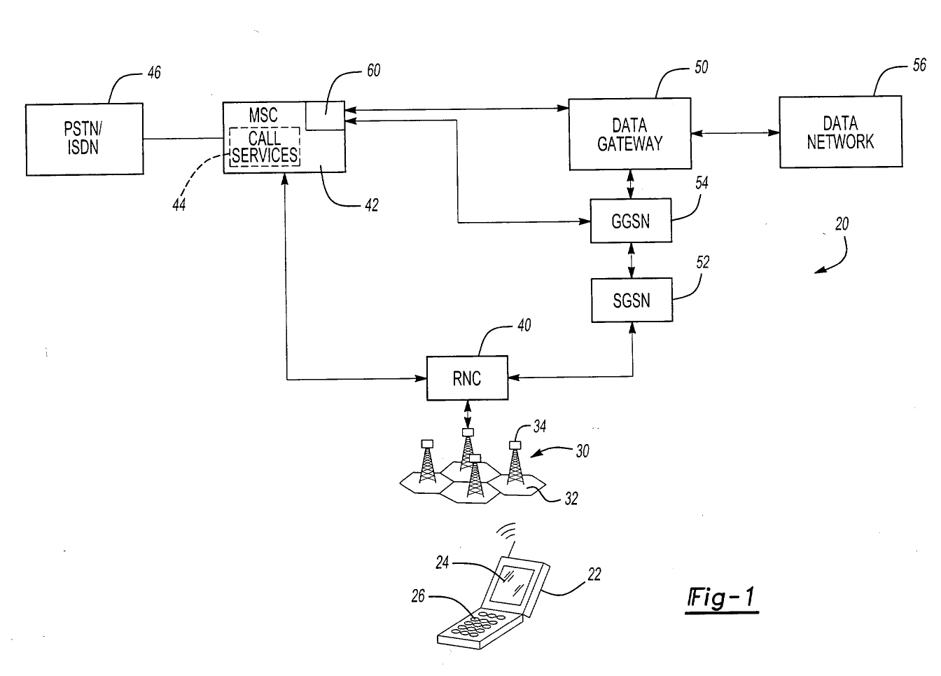

FIG. 1 schematically illustrates a wireless communication system 20 that facilitates wireless, circuit-switched voice communication services and packet data services for a subscriber using a mobile station 22.

The example mobile station 22 includes a visual display 24 and a manual input interface 26, such as a keypad, mouse, etc., that allows the mobile subscriber to have data access through a graphical user interface such as a browser presented on the display 24. The mobile station 22 is also capable of voice communication. This invention includes a variety of forms and styles of mobile stations 22. The illustrated example should not be construed to be limiting in any way.

The illustration schematically shows one example type of arrangement having separate circuit-switched voice and packet data networks designed according to UMTS. The illustrated system 20 schematically has a circuit-switched voice network or path on the left side of the illustration and a packet data network or path on the right side of the illustration. The invention is not limited to use in a UMTS system. The invention may be used in a variety of other systems that have separate circuit-switched voice and packet data paths such as a CDMA2000 or 3G CDMA network, for example.

The communication system 20 includes a cellular network 30 comprising a plurality of cells 32 that are established in a known manner. The illustrated example includes base stations 34 with appropriate hardware (i.e., controllers, transmitter, antennas, etc.) and software to service each of the cells 32 in a known manner.

The illustrated portions of the system 20 include base station controllers 40 associated with the base stations 34. In this example, the controller 40 comprises a radio network controller (RNC). Radio network controllers are known within the UMTS third generation architecture to provide a radio access network. The RNC 40 facilitates the mobile station 22 obtaining access to voice and data services through the cellular network 30 in a known manner.

A mobile switching center 42 includes a call services module 44 that operates in a known manner to access a public switch telephony network (PSTN) to facilitate voice communication services for the mobile station 22. Communication between the RNC 40 and the MSC 42 in one example occurs in a known manner using an interface that is known as Iu-circuit switched. The access between the MSC 42 and the PSTN 46 also occurs in a known manner.

“Voice services,” as used in this description, includes but is not necessarily limited to voice signal transmissions. Voice services include blended or mixed voice and data, voice and video or other combinations that may be supported through a circuit-switched network.

The communication system 20 also includes a data gateway that allows the subscriber using the mobile station 22 to have access to wireless data services (i.e., email, internet, etc.). “Data services,” as used in this description includes but is not limited to data in its strictest sense. Data services may include voice, video, audio or any combination of signal formats that are supported by a packet-switched network.

The illustrated example includes a WAP gateway 50. The mobile station 22 in such an example includes a corresponding WAP browser that is presented to the subscriber on the display 24 to facilitate access to the desired wireless data services.

WAP is one example method, but not the only method useful with this invention, for integrating voice and data services. One example includes a Web server with an application that connects the subscriber interface, provided by HTTP running over the IP connection to the mobile station, with the interface to the MSC. One other example includes a purpose-built server that uses an interface standard required to meet the needs of a particular situation. Given this description, those skilled in the art will be able to select the approach that best meets the needs in their particular situation.

In one example the data services are accomplished using a general packet radio service (GPRS). In the illustrated example, the RNC 40 communicates with the data gateway 50 through a serving GPRS support node (SGSN) 52 and a global GPRS support node (GGSN) 54. The GGSN serves as an anchor for a packet data session while the SGSN 52 provides mobility management along with the RNC 40 to maintain the packet data session as the subscriber moves through the network 30. The communication between the RNC 40 and the SGSN 52 occurs in a known manner using an interface that is known as lu-packet switched. As known, the packet data session handling for a particular mobile station 22 may change between RNCs and SGSNs, but the same GGSN 54 handles an entire packet data session for a given subscriber or mobile station 22.

The illustrated embodiment of the inventive arrangement includes a data-exchanging communication interface 60, which is part of the mobile switching center 42 in the illustrated example. The communication interface 60 facilitates exchanging data between the mobile switching center 42 and the data network through a gateway to the data network. In the illustrated example, the WAP gateway 50 or the GGSN 54 responsible for a current packet data session serve as the gateway. Depending on the necessary content of the communication, access directly through the data gateway 50 or the GGSN 54 may be selected to achieve system economies. In another example system, the PDSN anchoring a current session is the gateway with which the MSC exchanges data.

Those skilled in the art who have the benefit of this description will realize how to establish communication strategies for when to select direct communication with a data gateway 50 or a GGSN 54 (or the appropriate portions of the particular network with which they are dealing). Similarly, those skilled in the art who have the benefit of this description will be able to develop the programming necessary to accomplish the communication between the MSC 42 and the data network to meet the needs of their particular situation.

Although communication directly through the data gateway 50, the GGSN 54 or another appropriate portion of the packet-switched “side” of the system 20 are possible within a system designed according to this invention, the following description refers to exchanging data between the MSC 42 and the data gateway 50. It is to be understood that under appropriate circumstances, communication with the data gateway at least includes direct communication between the MSC 42 and the WAP gateway 50 or the GGSN 54 as it may facilitate more expedient communications under selected circumstances.

The communication interface 60 in one example comprises a device server added to the MSC 42. In one example schematically shown in FIG. 1A, the call services module 44 comprises software running on a call feature server 62 that also supports a UMTS device server software module 63 and a gateway device server software module 64. The operations of such servers associated with a MSC are known for facilitating wireless and line-based communication.

The communication interface 60 in this example includes a session initiation protocol (SIP) device server software module 65 that provides an abstraction of the packet data gateway interface to the call services module 44. In this illustration, the SIP server 66 is an example packet data gateway 50. There are a variety of ways of accomplish such an interface and those skilled in the art who have the benefit of this description will be able to develop appropriate software, firmware, hardware or a combination of them to meet the needs of their particular situation. In the illustrated example, the SIP device server module 65 operates analogously to an SS7 device server module 67 that facilitates the call services module 44 accessing the SS7 network 68.

In one example, the interface 60 uses IP transport and the known IETF session initiation protocol (SIP) or the known ITU-T H.323 protocol. The communication interface 60 allows for creating arbitrarily complex calls on the behalf of a subscriber to the wireless voice and data services because it facilitates exchanging data directly between the MSC 44 and the gateway 50.

The inventive arrangement allows for a subscriber to initiate a packet data service session and then the data gateway 50 to initiate data-exchanging communication with the mobile switching center 42. Alternatively, the subscriber may be in a voice communication session and the mobile switching center 42 initiates communication with the data gateway 50. The inventive arrangement allows for integrating voice and data communications in ways that extend beyond what was previously possible. The inventive arrangement effectively provides for communication between the circuit-switched “side” and the packet switched “side” of the system 20 that greatly enhances the available services to a subscriber.

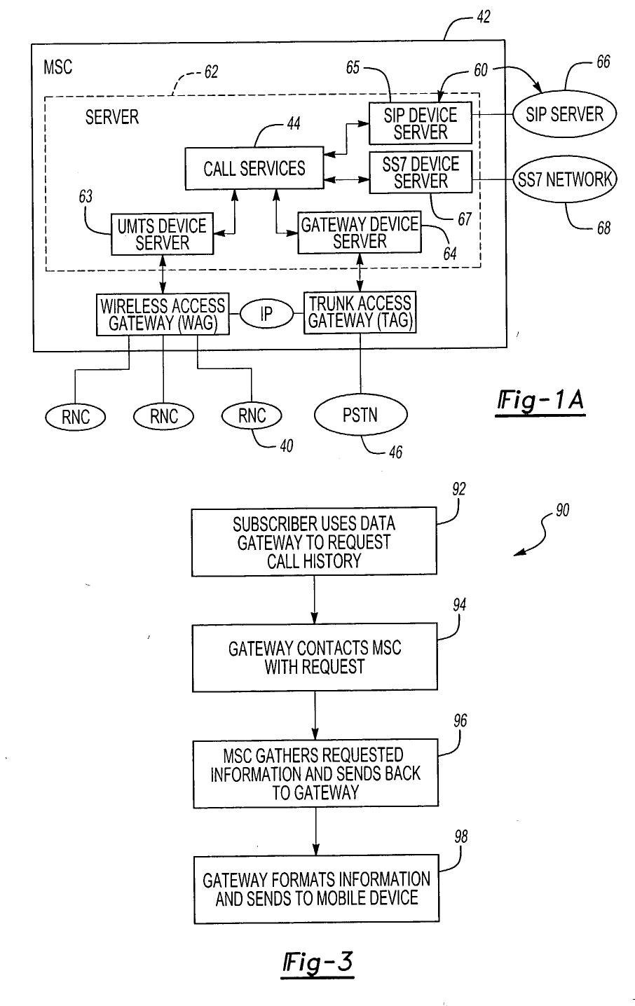

FIG. 2 is a flow chart diagram 70 summarizing an example service scenario that is possible with a system designed according to this invention. This type of service is useful when a subscriber is busy with a call on the mobile station 22, for example. It is also useful in situations where the subscriber may not immediately wish to answer an incoming call.

At 72 the MSC 42 receives an incoming call for the mobile station 22 from the PSTN 46. At 74, the MSC 42 determines whether the mobile station 22 is currently in use or the subscriber otherwise does not desire to answer the incoming call. Under such circumstances, the mobile switching center preferably accesses the data gateway 50 to alert the subscriber of the incoming call on the mobile station 22 data interface 24 with information such as the calling number, name of the person calling, etc.

At 76, the MSC 42 communicates with the data gateway 50 about the incoming call. The data gateway 50 then sends the incoming call information to the mobile station 22 display 24 at 78.

At this point the subscriber has the option of deciding how the incoming call should be handled. At 80, the subscriber uses the mobile station 22 to communicate to the gateway 50 what the desired call handling procedure should be. At 82, the data gateway processes the subscriber's selection. At 84, the data gateway 50 notifies the MSC 42, through the interface 60 of the subscriber's selection. The MSC 42 receives the selection of the subscriber and completes the call handling according to the subscriber's desire.

In one example, the MSC 42 facilitates playing a recorded announcement to the incoming caller to call back in a selected time period. In such an example, the subscriber has the option of deciding when would be a convenient time for the caller to call back.

In another example, the MSC 42 plays a voice prompt to the incoming caller requesting a call-back number. The response from the caller is then sent to digit recognition, processed by the MSC 42 and communicated to the data gateway 50 so that the call-back number is eventually displayed for the mobile subscriber on the display 24 of the mobile station 22.

In another example the MSC 42 requests a personal identification number from the incoming caller through a voice prompt. The caller's response is sent to digit recognition and then forwarded to the subscriber using the mobile station 22. The subscriber has the option of accepting the call in real time and preferably is presented with an identification of the caller that is associated with the personal identification number and recognizable by the subscriber (i.e., the incoming caller's name).

In another example where the subscriber has voice messaging available, the MSC 42 forwards the incoming call to voice messaging.

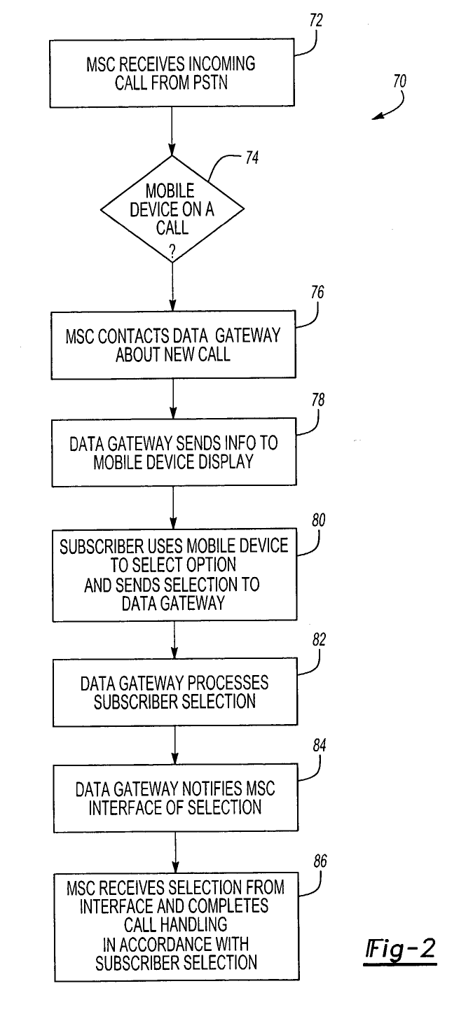

FIG. 3 is a flow chart diagram 90 illustrating another example service scenario available with the inventive arrangement. In this example, the subscriber obtains recent personalized call history information. At 92, the subscriber uses the data gateway 50 to request call history information using, for example, a WAP browser at the mobile station 22. The subscriber sends an inquiry to the data gateway 50 for details regarding recent voice calls within constraints that may be selected by the subscriber (i.e., certain time frames, calls meeting certain criteria, etc.). At 94, the gateway 50 seeks to obtain the information desired by the subscriber by contacting appropriate billing centers and the mobile switching center 42 as appropriate depending on the specific information requested by the subscriber.

For example, the subscriber may desire call history information from a period that has not been yet processed by a billing center. Under these circumstances, the MSC 42 has the requested information available and can communicate that to the gateway 50 so that the information may be transmitted to the subscriber. At 96, the MSC 42 gathers the requested information and sends that back to the gateway 50. At 98, the gateway 50 formats the information and sends that to the mobile station 22.

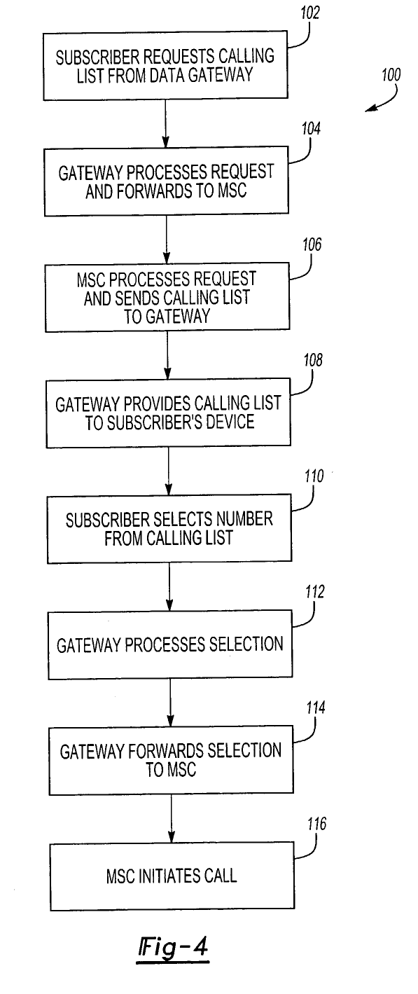

FIG. 4 includes a flow chart diagram 100 that summarizes another example integrated voice and data service made possible by this invention. At 102, the subscriber requests a calling list that is maintained by the MSC 42 such as, for example, a speed-dial list, for the subscriber. At 104, the gateway 50 processes the request and forwards that to the MSC 42. At 106, the MSC processes the request and sends the calling list back to the gateway 50. At 108, the gateway provides the calling list to the subscriber's mobile station 22.

The subscriber preferably has the ability to utilize the same interface to make changes to the calling list or to initiate a voice call. In the example of FIG. 4, the subscriber selects a number from the calling list at 110. The gateway 50 processes the selection at 112 and forwards the selection to the MSC 42 at 114. The MSC then initiates the voice call at 116 so that the subscriber is able to use the mobile station 22 to handle the voice call.

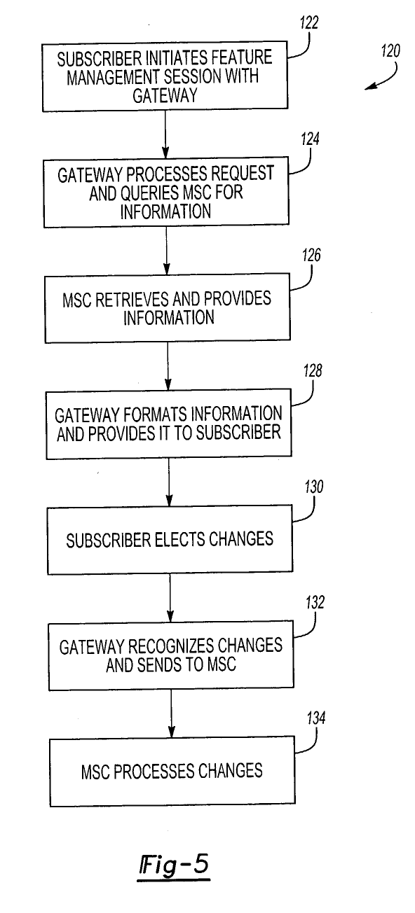

FIG. 5 shows flow chart diagram 120 that summarizes another integrated voice and data service available with this invention. In this example, the subscriber has the ability to select from a plurality of available features to customize the features available on the subscriber's plan. In the flow chart 120, the subscriber initiates a feature management session with the gateway 50 at 122. At 124, the gateway processes the request and queries the MSC 42 for data as needed to obtain the current feature status requested or subscribed to by the subscriber. At 126, the MSC 42 retrieves the requested information and provides it to the data gateway 50. At 128, the gateway 50 formats the information and provides it to the subscriber on the mobile station 22.

The subscriber in one example is able to initiate changes to the selected features at 130. The gateway 50 recognizes theses changes and forwards that information to the MSC 42 at 132. The final step in the flow chart of FIG. 5 includes the MSC 42 processing the requested changes to the subscriber's selected plan features.

The type of information on the display 24 available to a subscriber under this type of scenario in one embodiment includes a display showing the features currently subscribed to by the subscriber. Further details regarding each of the features, such as the number used for call-forwarding services also can be made available. Further, features that are available but not selected by the subscriber may be shown. Through appropriate use of the graphical user interface or WAP browser on the display 24, the subscriber is able to elect the desired features or changes, which are ultimately processed by the MSC 42 to update the subscriber's available features.

This type of service may also be used for customizing the features selected by the subscriber, provided that such capability is made available by the network operator. For example, the subscriber may select how various available features are to perform and to communicate those choices through data gateway 50. The subscriber's selected customization can then be implemented by the MSC. For example, the subscriber may desire specific handling of incoming calls when the subscriber is on a voice call compared to a different handling strategy when the subscriber is in a data session. Relatively simple customizations may be selected using a WAP browser on a display 24 of a mobile device 22.

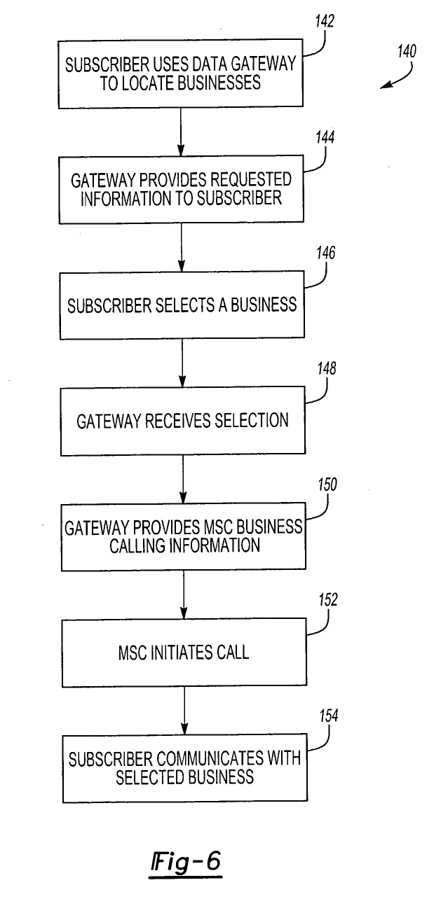

FIG. 6 includes a flow chart diagram 140 that summarizes another integrated voice and data service provided by the inventive arrangement. At 142, the subscriber uses the data gateway 50 to obtain information about or to locate business establishments within a selected region. For example, the subscriber may desire to locate restaurants within a selected range of distance from the current location of mobile station 22. The subscriber requests this information through the data gateway 50, which obtains the information through a data base available on the internet in a known manner, for example. In one example, the gateway 50 includes a WAP server that queries the Gateway Mobile Location Center (GMLC), the MSC 42 or both to determine the subscriber's approximate geographical location. The WAP server then uses that information to make an appropriate query of a business data base. The resulting list is then sent by the WAP server and the gateway 50 to the WAP browser on the display 24 of the mobile station 22. At 144, the gateway provides the requested information to the subscriber.

At 146, the subscriber selects one of the restaurants (or other business establishment) through the WAP browser or other graphical user interface on the mobile station 22 and that is communicated to the data gateway 50 at 148.

In one example, the subscriber selection indicates to the gateway 50 that the subscriber desires to establish a voice call with the selected restaurant or other business.

In one example, as described above, the subscriber is then given an option to initiate a call to a selected business based upon location, familiarity, menu summary, type of cuisine or other information available on the browser at the mobile station 22. When the subscriber selects one of the businesses, the MSC 42 initiates a voice call as described above.

At 150, the gateway 50 provides the selected business information to the MSC 42 through the interface 60. At 152, the MSC 42 initiates the voice call on behalf of the subscriber. At 154, the subscriber conducts a voice call with the selected restaurant or business based upon the call initiated by the MSC 42 responsive to information received from the subscriber at the gateway 50. This ability is advantageous because prior to this invention, the MSC would not initiate such a voice call. Instead, prior to this invention, the mobile station would have to be used to initiate the necessary voice call, a capability not supported by many mobile stations.

In another example, where restaurants participate in an appropriate subscription service, the subscriber may be able to make a reservation at the restaurant electronically. In such circumstances, the WAP server associated with the gateway 50 contacts the restaurant electronic scheduling server to make a reservation for the subscriber indicating the desired time, number of individuals in the party and any seating preferences. The eventual results of the reservation request are displayed to the subscriber on the WAP browser at the mobile station 22. In one example, the subscriber then has the option of accepting the available reservation. In another example, the reservations are complete when forwarded to the mobile station 22.

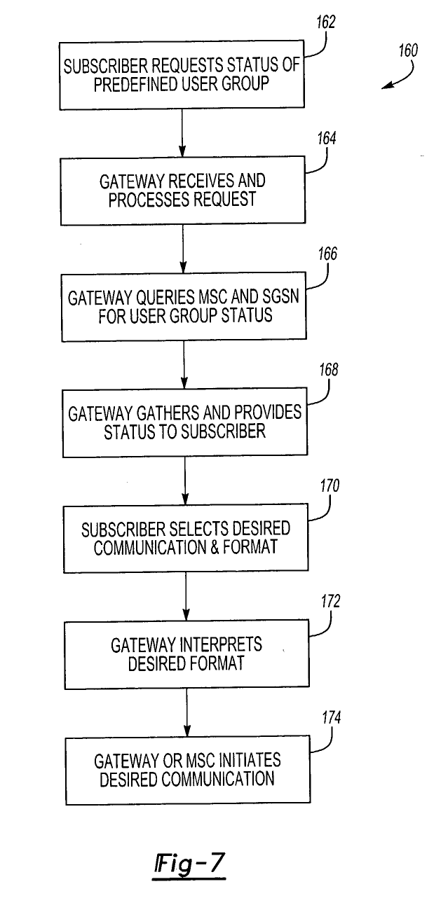

FIG. 7 includes a flow chart diagram 160 that summarizes a locator service available with the inventive arrangement. The subscriber is able to identify certain individuals (i.e., family, friends, co-workers, etc.) as one or more user groups. With such a service, the subscriber is able to locate the members of the selected user group and obtain information regarding their locations on the display 24 of the mobile station 22.

At 162, the subscriber requests the status of the predefined user group. The data gateway 50 receives and processes the request at 164. At 166 the gateway queries the MSC 42 and SGSNs 52 as needed to obtain current status for the users in the predefined user group. The information obtained by the data gateway 50 is then provided to the subscriber at 168.

In one example, the WAP browser on the display 24 includes information for each user such as name, approximate distance from the subscriber's current location, approximate location and status (i.e., on a voice call, in chat, in a data session, available, not locatable, etc.).

In one example, the subscriber is then given several options available through the WAP browser to communicate with one or more members of the user group. In the example of FIG. 7 the subscriber selects with whom they wish to communicate (i.e., one or more of the members of the user group) and the desired format (i.e., voice, email messaging, etc.) at 170. The subscriber may be able to chat with a selected friend, join a chat group, send a message to one or more members of the user group or call one or more of the user group individuals. At 172, the gateway 50 interprets the subscriber request and the desired format. Depending on what has been selected, the gateway or the MSC 42 initiates the desired communication. In the event of email messaging, for example, the gateway 50 need not necessarily communicate with the MSC 42 to carry out the subscriber's desires. When a voice call is desired, on the other hand, the gateway 50 communicates through the interface 60 so that the MSC 42 initiates the appropriate voice call.

Another example service available with the inventive arrangement is to integrate voice messaging and data messaging. In one example, the MSC 42 has a co-resident or integrated voice message server. Whenever voice messages are processed by the MSC 42, information is provided to the data gateway 50 that is then coordinated with the message for presentation to the subscriber. In one example, when the subscriber desires to listen to a voice mail message, the WAP browser presents information on the display 24 regarding information such as the time the message was left, duration of the message, the calling number and any indicated message importance level. Similarly, when the subscriber accesses messages through the WAP browser, the subscriber has the options of playing a message, deleting a message, playing a selected portion of a message or forwarding a message to another subscriber, for example, even though the voice message is “maintained” by the MSC 44. In either scenario, while the subscriber initiates message retrieval through either the MSC 42 or the data gateway 50, appropriate data-exchanging communication between the MSC 42 and gateway 50 accomplishes all of the subscriber's desired message handling without requiring the subscriber to hang up or disconnect from one session to initiate another.

In another example, the WAP browser facilitates the subscriber attaching a voice mail message to an electronic mail message that can then be sent through the internet.

As can be appreciated from this description, a variety of integrated wireless voice and data services are available through the inventive arrangement, which includes a communication interface for exchanging data between a mobile switching center and a data gateway.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of integrating wireless voice and data services, comprising the steps of:
facilitating voice communication for a mobile subscriber through a mobile switching center;
facilitating data services for the mobile subscriber through a data network; and
exchanging data between the mobile switching center and the data network to selectively integrate the voice and data services on behalf of the mobile subscriber.

2. The method of claim 1, including accessing the data network by the mobile switching center.

3. The method of claim 1, including accessing the mobile switching center by the data network.

4. The method of claim 1, including interfacing between the mobile switching center and the data network through at least one of a WAP gateway, a GGSN or a PDSN.

5. The method of claim 1, including receiving an incoming call for the mobile subscriber at the mobile switching center, obtaining information from the data network regarding the mobile subscriber's preferences for handling the incoming call, and responding to the incoming call using the mobile switching center responsive to the information obtained from the data network.

6. The method of claim 5, including using the data network to notify the mobile subscriber of the incoming call and obtaining a desired call handling from the subscriber and communicating the obtained subscriber desire from the data network to the mobile switching center.

7. The method of claim 1, including using the mobile switching center for maintaining information regarding the mobile subscriber's subscription, receiving a request for information regarding the mobile subscriber's subscription through the data network, obtaining the requested information from the mobile switching center and using the data network to provide the requested information to the mobile subscriber.

8. The method of claim 7, wherein the subscription information includes at least call history information or selected subscription plan features.

9. The method of claim 8, including allowing the mobile subscriber to change the selected features, determining the desired changes using the data network and implementing the desired changes using the mobile switching center.

10. The method of claim 1, including providing the mobile subscriber with information regarding a predefined listing available through the data network and allowing the mobile subscriber to select a desired communication format with at least one of the members of the listing and using at least one of the data network or the mobile switching center to initiate the communication selected by the mobile subscriber.

11. The method of claim 10, including maintaining a user group listing and providing the mobile subscriber with information regarding members of the user group listing current status and location based upon the information obtained regarding the members from at least one of the data network or the mobile switching center.

12. The method of claim 1, including receiving a request at the data network from the mobile subscriber for information regarding potential contacts within mobile subscriber-defined selection criteria, obtaining the requested information using the data network, providing the requested information to the mobile subscriber and using at least one of the mobile switching center or the data network to initiate a communication between the mobile subscriber and a subscriber-selected one of the contacts.

13. The method of claim 12, including using the mobile switching center to initiate a voice communication between the mobile subscriber and the selected contact.

14. A method of using integrated wireless voice communication and data services, comprising the steps of:
initiating a data session through a data network; and
prompting a gateway of the data network to exchange data with a mobile switching center that facilitates voice communication.

15. The method of claim 14, including choosing an option that causes the data network gateway to initiate exchanging data with the mobile switching center.

16. The method of claim 14, including responding to a communication from the data network gateway that is based upon exchanging data between the mobile switching center and the data network which was initiated by the mobile switching center.

17. The method of claim 14, including prompting the mobile switching center, through the data network, to initiate a voice call.

18. A wireless communication system, comprising:
a data network that is accessible by a mobile subscriber to provide data services to the mobile subscriber; and
a mobile switching center that accesses a telephony network to facilitate voice communication for the mobile subscriber, the mobile switching center having an interface for exchanging data with the data network on behalf of the mobile subscriber.

19. The system of claim 18, wherein the mobile switching center selectively initiates exchanging data with the data network.

20. The system of claim 18, wherein the data network selectively initiates exchanging data with the mobile switching center.
